(19) United States
(12) Patent Application Publication
(10) Pub. No.: US 2013/0319561 A1
(43) Pub. Date: Dec. 5, 2013

(54) Hydraulic Control Block And Hydraulic System

(71) Applicant: Liebherr-France SAS, Colmar Cedex (FR)

(72) Inventors: Frank HELBLING, Sasbach (DE); Christoph MUELLER, Colmar (FR)

(73) Assignee: Liebherr-France SAS, Colmar Cedex (FR)

(21) Appl. No.: 13/901,276

(22) Filed: May 23, 2013

(30) Foreign Application Priority Data
May 31, 2012 (DE) 10 2012 010 847.8

(51) Int. Cl. F15B 13/08

(52) U.S. Cl. CPC F15B 13/0803
USPC 137/884

(57) ABSTRACT

A hydraulic control block has at least two pressure supply circuits, which each include one or more hydraulic consumer ports, and at least two hydraulic pump ports. A valve arrangement is provided, by way of which each of the at least two pump ports can selectively connect with at least one of the pressure supply circuits selectively individually or in combination with at least one of the remaining pump ports. At least one direct connection of a consumer port is provided per pump port.

This invention relates to a hydraulic control block for actuating at least two hydraulic consumers.

Hydraulic control blocks include an integrated hydraulic circuit. To the outside, the control block includes various ports, in order to be able to connect specific hydraulic components, for example hydraulic consumers or hydraulic pumps, with each other via the control block.

Control blocks are used in construction machines, in particular earth-moving machines or lifting devices, wherein the control block performs the hydraulic actuation of at least a part or all of the hydraulic consumers of the machine. In addition, it is know to equip such control blocks with more than one pump port. The integrated circuit arrangement provides for the summation of the pump delivery volumes. Due to the pump combination, the individual pumps can be dimensioned smaller, which can distinctly reduce the manufacturing and operating costs.

The pump summation, however, often is too inflexible as regards the consumer to be supported. In addition, a prioritisation of particular consumers regularly is desirable.

The object of the present invention consists in indicating a novel modular concept for a hydraulic control block, which permits large pump volume flows and at the same time allows a particularly flexible pump-side summation of the volume flows.

This object is solved by a hydraulic control block according to the features of claim 1. Accordingly, a hydraulic control block comprises at least two pressure supply circuits, which each include one or more hydraulic consumer ports. A part of the consumer ports accordingly is fed via independent supply circuits. In addition, the control block includes at least two hydraulic pump ports.

Ideally, the control block includes exactly two or three pump ports.

According to the invention, there is furthermore provided a valve arrangement by means of which each of the at least two pump ports selectively can be connected or combined with at least one pressure supply circuit, individually or in combination with at least one more of the remaining pump ports. Preferably, each individual supply circuit selectively can be fed by each pump port or by an arbitrary pump port combination. It is also conceivable that each of the at least two pump ports selectively can be connected with at least two or all of the pressure supply circuits in parallel, individually or in combination with at least one of the remaining pump ports.

The valve arrangement according to the invention allows a particularly flexible pump-side summation of the pump delivery rates. If necessary, the hydraulic control block can supply particularly large volume flows to each of the connected consumers. From safety aspects, the invention also realizes a particularly high-quality system, since individual consumers do not have a consumer-side summation of the pump delivery rates and the number of the control elements thus is reduced.

According to the invention, there is furthermore provided at least one direct connection of a consumer port per pump port. Via the direct port, particular consumer ports or consumers selectively can be prioritised in the hydraulic system. In a system with two pump ports, at least two consumers accordingly can be prioritised. The prioritisation allows a preferred volume flow to the consumer. An expanded design with at least three pump ports accordingly allows the prioritisation of at least three consumers.

It is conceivable that the valve arrangement comprises at least four valves. A suitable type of valve for example is a directional valve. At least two or all of the valves can be designed identical or unequal.

In a preferred configuration of the valve arrangement, each pump port can be connected with the pressure supply circuits via at least two valves. The switching condition of the at least two valves selects the pressure supply circuit to be fed. Such valve arrangement allows a particularly flexible control, since each of the pressure supply circuits selectively can be fed by exactly one of the connected pumps. In addition, this valve arrangement allows an arbitrary pump summation of two or more pump ports for feeding at least one or more pressure supply circuits.

At least one valve of the valve arrangement can be a black-and-white or proportional valve, a piston valve, a logic valve in cartridge construction, a flow control valve or a pressure limiting valve. An identical or different construction of the individual valves is possible.

The individual consumer ports of the respective pressure supply circuits preferably are connected with the pressure supply circuit via at least one control valve. The control valve, in particular a control piston, serves for consumer control, i.e. for activating, deactivating or regulating the connected consumers.

Furthermore, it can be expedient that one or more of the consumer ports connected directly to the pump port are connected with the pump port via at least one control valve, in particular a control piston.

At least one of the control valves used for the consumer ports of the pressure supply circuits or the directly connected consumer ports for example can be a 6/3-way valve, a 4/3-way valve, a combination of logic valves with or without flow control function, or a directional valve with upstream or downstream pressure scale.

As an additional safety aspect, the integration of a parallel shut-down path per pump port can turn out to be particularly advantageous. In particular, each pump port includes at least one parallel shut-down path. Via the shut-down path, the pump volume flow can be guided directly into a hydraulic tank.

The shut-down path preferably is controlled via a directional valve. The closed condition allows the build-up of pressure in the entire hydraulic system, in particular in the pressure supply circuits or the direct connections. When the directional valve is opened, on the other hand, the system pressure in the circuit starts to fall and the delivery volume of the respective pump is delivered directly into the tank.

Conceivable types of valve for the arrangement in the shut-down path in particular include a black-and-white or proportional valve, a piston valve, a logic valve in cartridge construction, a flow control valve or a pressure limiting valve.

To inhibit a backflow of the oil to the consumer of lower load, when different consumers are used at the same time, it is found to be expedient to connect one or more consumer ports with the pressure supply circuit or the pump port via one or more check valves. The check valves inhibit the backflow to the pressure supply circuit or to the pump port.

It is also possible that at least one consumer port of the pressure supply circuit indirectly is connected in addition with at least one direct connection of at least one pump port via at least one valve. This construction allows the prioritisation of at least one additional hydraulic consumer via the additional supply line.

The invention furthermore relates to a hydraulic system with at least one control block according to the invention or an advantageous embodiment of the control block. The advantages and properties of the hydraulic system quite obviously correspond to those of the control block according to the invention, so that a repetitive description will be omitted at this point.

In addition to the control block, the hydraulic system comprises at least two hydraulic pumps and a plurality of hydraulic consumers, which each are connected with the corresponding ports of the control block.

The hydraulic system according to the invention serves for the hydraulic drive of a construction machine, in particular a lifting gear, transportation implement or an earth-moving machine. One or more hydraulic consumers for example represent a piston-cylinder unit, some other actuator for operating a shovel, boom, arm or a similar option. Furthermore, one or more hydraulic consumers comprise a hydraulic drive, for example a hydraulic motor, for moving the implement or machine or for carrying out some other machine movement, for example for driving a stewing gear.

Further advantages and details of the invention will be explained in detail below with reference to two exemplary embodiments illustrated in the Figures. In the drawing:

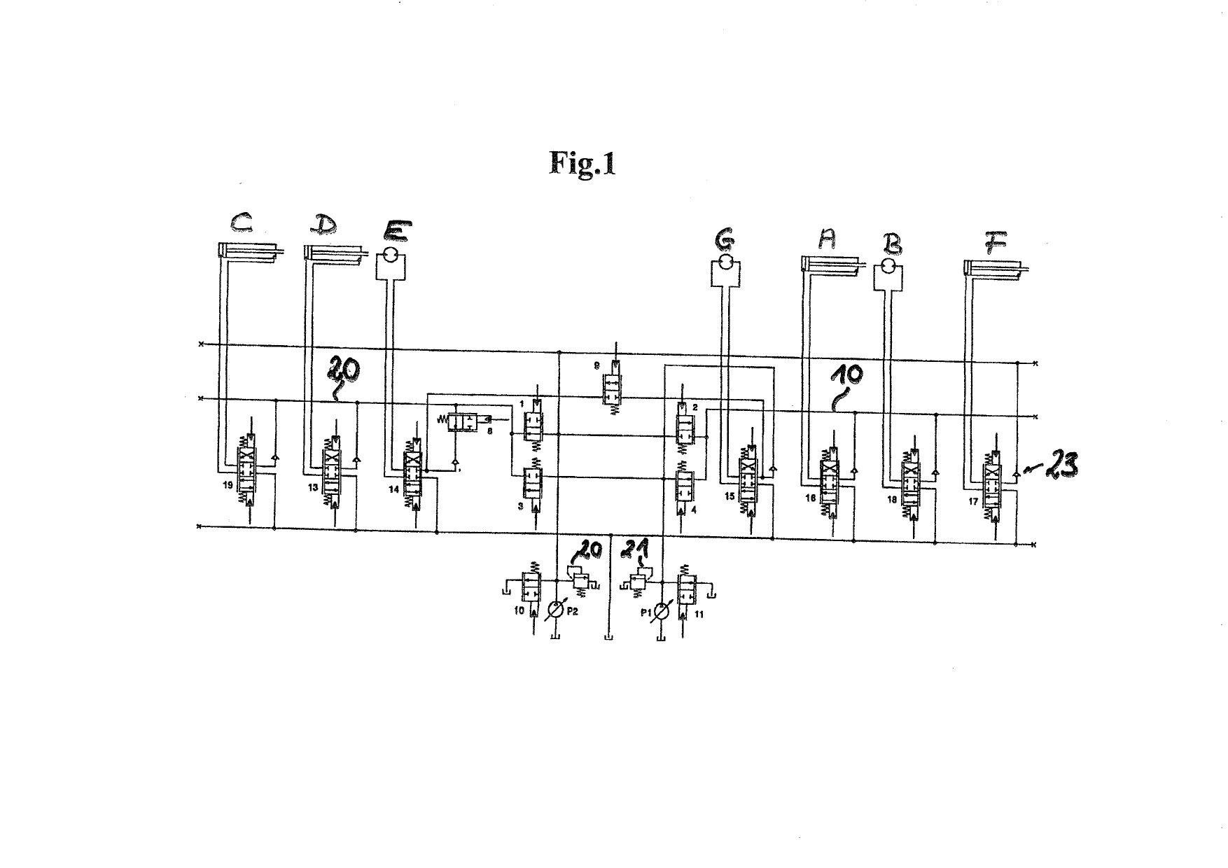

FIG. 1: shows a hydraulic circuit diagram of a first design variant of the hydraulic system according to the invention; and

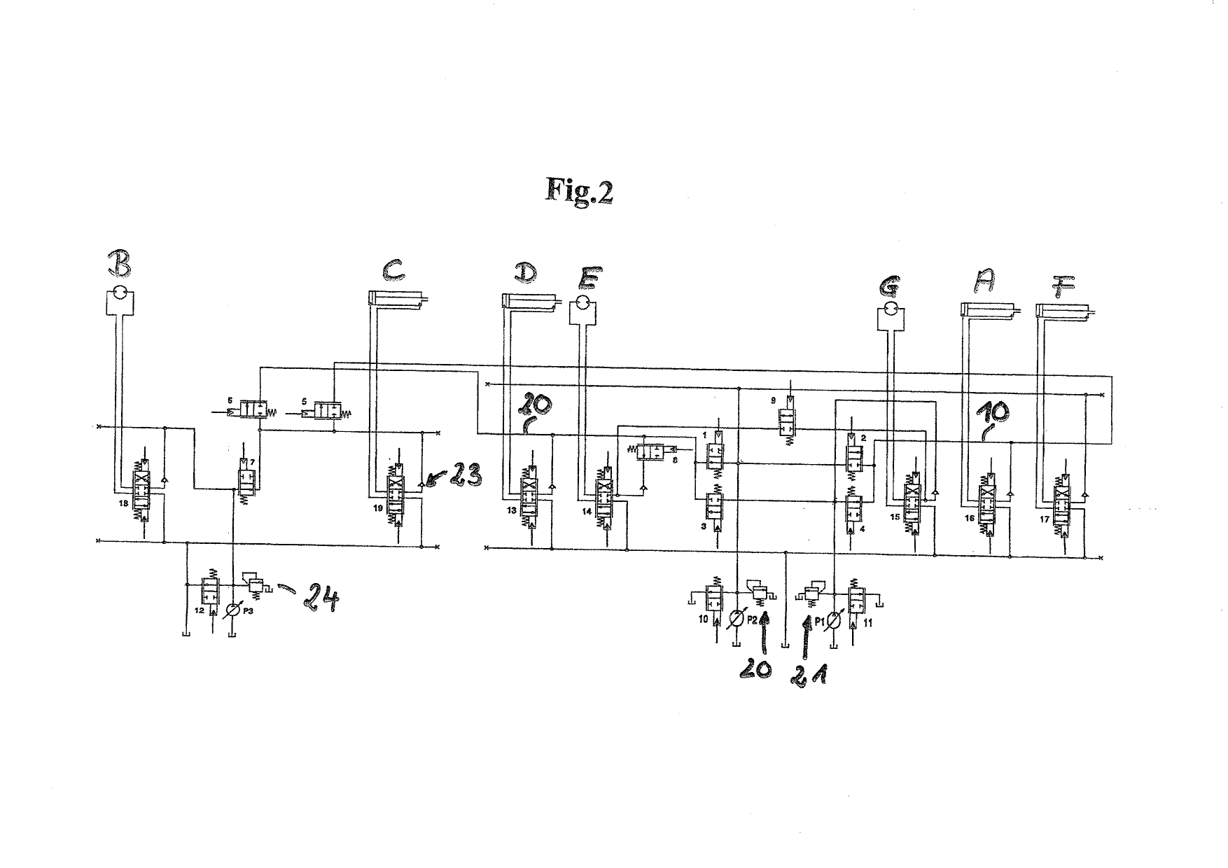

FIG. 2: shows a second hydraulic circuit diagram of a further design variant of the hydraulic system according to the invention.

FIG. 1 shows a first variant of the control block or system according to the invention, which is designed as two-circuit system and comprises the two pumps P1, P2. The control block includes a right supply channel 10, to which the consumers A and B are connected. In addition, a further supply channel 20 is provided on the left side of the control block, to which the consumers C, D and E are connected.

The two pumps P1, P2 now can selectively be connected with one or both supply channels 10, 20 individually or jointly via a valve arrangement. The valve arrangement substantially consists of the four valves 1 to 4.

The valves 1 to 4 are designed as 2/2-way valves with a flow position and a blocking position, wherein the flow direction always is directed in direction of the pressure supply circuits. In the neutral position, the valves 1 and 4 are opened and the valves 2, 3 are closed, so that the pump P1 feeds the right supply circuit 10 and the pump P2 feeds the left supply circuit 20.

The consumers A-E selectively are connected with the pumps P1 or P2 or both in combination. The valves 1 and 3 allow the pump summation of the pumps P1, P2 to the supply channel 20 of the left control block half, while the valves 2 and 4 provide for the pump summation of the pumps P1, P2 to the supply channel 10 of the right control block half.

In addition, each of the two pumps P1, P2 feeds an associated consumer port. The consumer connected thereto is operated with a higher priority as compared to the remaining consumers. In the exemplary embodiment of FIG. 1, for example, the consumer F is prioritised higher and directly coupled with the pump P2. The same applies for the consumer G, which is directly connected to the pump P1.

Via a 4/3-way valve 13 to 19, each consumer A to G additionally is connected either to one of the supply channels 10, 20 or directly to one of the pumps P1, P2. Each 6/3-way valve offers two flow positions, for example for the forward/backward operation of the consumer, and a blocking position in which all valve ports are blocked. All directional valves 13 to 19 are blocked in their neutral position.

In combination with the direct connection of the consumers F and G, the valve arrangement 1 to 4 allows a prioritisation of the consumers F, G and a simultaneous parallel operation of the remaining consumers A to E.

Furthermore, a connection of the consumer E is provided on the one hand at the pressure supply circuit 20 and also via the two valves 8, 9 at the direct port of the pump P1. Both valves 8, 9 are 2/2-way valves each with a flow position and a blocking position, wherein valve 9 allows a bidirectional flow. This provides both for a volume flow of the pump P2 to the direct port of the pump P1 or to the consumer G and a volume flow of the pump P1 to the consumer E. When the valve 9 is opened and valve 8 is closed, the pressure supply of the two consumers E, G is effected by the pump P1. Valve 9 is closed in the neutral position, while valve 8 is opened.

The control block of the invention according to the exemplary embodiment of FIG. 1 can be used in a hydraulic excavator and performs the entire actuation of the used hydraulic components for carrying out the excavator functions. The consumers E, G and B for example are hydraulic motors for the traction drive or for driving the uppercarriage stewing gear, while the consumers A, C, D and F represent piston-cylinder units for operating the excavator arm, boom, shovel or some other hydraulic component.

The traveling gear operated via the hydraulic motor G is fed via the pump P1 with prioritisation. In addition, a further hydraulic motor is provided for operating the traveling gear. When both consumers E, G are to be supplied in parallel via both pumps P1, P2 for driving, both valves 8, 9 must be open.

Via the valves 10, 11 a safety-relevant shut-down path is realized per pump P1, P2. In the neutral position, both valves 10, 11 are opened. When the valves 10, 11 are closed, the volume flow of the pumps P1, P2 regularly is delivered into the pressure supply circuits 10, 20 or to the consumers F, G prioritised higher for pressure build-up. If necessary, the valves 10, 11 can be opened individually or in parallel, in order to deliver the delivery volume of the pumps P1, P2 directly into the connected tank.

In addition, pressure limiting valves 20, 21 are directly connected to the pumps P1, P2 for limiting the maximum admissible pressure build-up.

When the supply channel of the prioritised consumer of pump P2 is guided through all sections, this section selectively can be attached to the right or left control block half. Here as well, the pump summation of P1 and P2 can be effected by valves 1 and 3 or 2 and 4.

The check valves 23 in the branches to the control pistons 13 to 19 of the individual consumers A to G prevent a backflow of the oil to the consumer of lower load, when different consumers are used at the same time.

An expanded version of the hydraulic system or control block according to the invention is shown in FIG. 2. This representation shows the structure of a three-circuit system, wherein here an additional pump P3 is integrated as compared to the design variant shown in FIG. 1. In the illustrated three-circuit system, the consumer B is prioritised in addition to the consumers F, G, in that the same is directly connected to the pump P3.

In addition, the volume flow of the pump P3 selectively can be passed into one or both pressure supply circuits 10, 20. For this purpose, valve 7 must always be opened. Opening the valve 5 allows to feed the volume flow of the pump P3 into the right supply channel 10, whereas valve 6 opens the access to the left supply channel 20.

Analogous to the pumps P1, P2, the additional pump P3 likewise comprises a parallel shut-down path with the valve 12 as safety function and the pressure limiting valve 24.

All valves 1 to 12 in FIGS. 1 and 2 can be designed as black-and-white or proportional valves, piston or logic valves in cartridge construction. Depending on the functional arrangement, a design as flow control valve or pressure limiting valve also can be conceivable.

Due to the modular design of the consumer sections 13 to 20, these valves each can be designed as 6/3-way valves, 4/3-way valves, combination of logic vales with or without flow control function or of directional valves with upstream or downstream pressure scale.

1. A hydraulic control block comprising:
at least two pressure supply circuits, each of the pressure supply circuits including at least one hydraulic consumer port,
at least two hydraulic pump ports, and
a valve arrangement, by which each of the at least two pump ports selectively is connectable with at least one pressure supply circuit individually or in combination with at least one of the remaining pump ports,
wherein at least one direct connection of a consumer port is provided per pump port.

2. The control block according to claim 1, wherein the valve arrangement comprises at least four directional valves, and wherein each pump port selectively is connectable with one or more of the at least two supply circuits via at least two valves.

3. The control block according to claim 1, wherein the at least one consumer port of the pressure supply circuits is connected with the at least one pressure supply circuit via at least one control valve for consumer control.

4. The control block according to claim 1, wherein the at least one consumer port is connected with at least one of the pump ports via at least one control valve.

5. The control block according to claim 4, wherein the at least one control valve is a 6/3-way valve, a 4/3-way valve, a combination of logic valves with or without flow control function, or a directional valve with upstream or downstream pressure scale.

6. The control block according to claim 1, wherein at least one of the pump ports includes at least one parallel shut-down path.

7. The control block according to claim 6, wherein the shut-down path provides a direct connection switchable by means of a valve between pump port and hydraulic tank.

8. The control block according to claim 1, wherein at least one valve of the valve arrangement and/or a shut-down path is a black-and-white or proportional valve, a piston valve, a logic valve in cartridge construction, a flow control valve or a pressure limiting valve.

9. The control block according to claim 1, wherein the at least one consumer port is connected with at least one of the pressure supply circuits or with at least one of the pump ports via at least one check valve.

10. The control block according to claim 1, wherein a consumer port of at least one of the pressure supply circuits additionally is connected with at least one direct connection of a pump port via a valve.

11. A hydraulic system for hydraulic control of a construction machine comprising at least one control block according to claim 1.

12. A construction machine, earth-moving machine, transportation implement, or lifting gear, comprising a control block according to claim 1.

13. The control block according to claim 3, wherein the at least one control valve is a 6/3-way valve, a 4/3-way valve, a combination of logic valves with or without flow control function, or a directional valve with upstream or downstream pressure scale.

14. A hydraulic system for hydraulic control of a construction machine comprising at least one control block according to claim 2.

15. A hydraulic system for hydraulic control of a construction machine comprising at least one control block according to claim 3.

16. A hydraulic system for hydraulic control of a construction machine comprising at least one control block according to claim 4.

17. A construction machine, earth-moving machine, transportation implement, or lifting gear, comprising a control block according to claim 2.

18. A construction machine, earth-moving machine, transportation implement, or lifting gear, comprising a control block according to claim 3.

19. A construction machine, earth-moving machine, transportation implement, or lifting gear, comprising a control block according to claim 4.

20. A construction machine, earth-moving machine, transportation implement, or lifting gear, comprising a control block according to claim 5.
